(19) United States
(12) Patent Application Publication
(10) Pub. No.: US 2026/0220027 A1
(43) Pub. Date: Jul. 30, 2026

(54) ARTIFICIAL INTELLIGENCE FRAMEWORK FOR SYSTEM FORENSICS

(71) Applicant: Robert Bosch GmbH, Stuttgart (DE)

(72) Inventors: Jared EVANS, Sunnyvale, CA (US); Antoine ROUX, Mountain View, CA (US); Moritz DECHANT, San Francisco, CA (US); Rose MA, Sunnyvale, CA (US); Sam HESHMATI, Campbell, CA (US); Kehao LI, San Jose, CA (US); Carlos CUNHA, Menlo Park, CA (US); Saurav KUMAR, Fremont, CA (US); Zubin ABRAHAM, Sunnyvale, CA (US); Loukik BHANDARI, San Jose, CA (US)

(21) Appl. No.: 19/041,396

(22) Filed: Jan. 30, 2025

(51) Int. Cl. G06F 11/362

(52) U.S. Cl. CPC G06F 11/3636

(57) ABSTRACT

Artificial intelligence systems for system forensics and performance optimization through continuous learning models are disclosed. The described framework includes an orchestrator managing AI agents, which analyze multimodal event data to detect anomalies and identify root causes. The system utilizes a lifelong learning repository to store and access historical data, enabling continuous adaptation and expert-in-the-loop feedback. The method involves receiving multimodal event data, managing AI agents to detect anomalies, and recommending resolutions based on historical data and expert validation.

### TECHNICAL FIELD

The present disclosure relates to artificial intelligence systems, specifically to

frameworks for system forensics and performance optimization through continuous learning models.

### BACKGROUND

In recent years, the complexity of systems across various domains, such as autonomous vehicles, healthcare, and industrial equipment, has increased significantly. These systems generate vast amounts of data, which are important for monitoring and enhancing system performance. However, the sheer volume and diversity of this data present significant challenges in identifying, classifying, and understanding the root causes of unwanted or unforeseen behaviors. Traditional methods of system analysis and forensics often rely on manual processes, which are time-consuming and prone to human error. Moreover, these methods struggle to adapt to the evolving nature of data and system requirements, leading to inefficiencies in maintaining system robustness.

Existing solutions, such as automated machine learning frameworks, aim to streamline certain aspects of data analysis but often lack the ability to adapt to new data without forgetting previous information. Additionally, these solutions may not effectively incorporate expert feedback, which is crucial for aligning system operations with human preferences and domain-specific knowledge. The absence of a comprehensive framework that integrates continuous adaptation, expert feedback, and modular orchestration limits the ability to efficiently monitor and optimize complex systems. This gap underscores the need for an innovative approach that can address these challenges and enhance the robustness and performance of modern systems.

### SUMMARY

In an embodiment, a method for troubleshooting and improving software programs or physical systems with continuous learning includes: receiving target-system multimodal event data generated from execution of a target system, wherein the target-system multimodal event data includes diagnostic data, telemetry, and configuration data; providing a lifelong learning repository that includes previously-stored multimodal data and previously-stored detected anomalies from prior executions of the target system or other target systems; delivering the target-system multimodal event data to an orchestrator; utilizing the orchestrator to manage a plurality of artificial-intelligence (AI) agents, wherein the orchestrator selects, based on the target-system multimodal event data, a subset of the AI agents to perform operations including detecting an anomaly in the target-system multimodal event data, accessing the lifelong learning repository of the previously-stored multimodal data and the previously-stored detected anomalies, performing specialized tasks tailored to that AI agent regarding the detected anomaly based on the previously-stored multimodal data and the previously-stored detected anomalies in the lifelong learning repository, along with previously-computed model weights and hyperparameters in the lifelong learning repository, to identify candidate root-causes of the detected anomalies, and delivering an outcome of the specialized tasks to the orchestrator; and at the orchestrator, determining a recommending resolution to the detected anomalies based on the outcomes from the subset of AI agents and the previously-stored multimodal data and the previously stored detected anomalies in the lifelong learning repository.

In another embodiment, a non-transitory computer-readable medium comprises instructions that, when executed by a processor, cause the processor to perform the above steps.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 illustrates an artificial intelligence system forensics framework (AISFF), according to an embodiment.

FIG. 4 is a block diagram illustrating the interaction between the orchestrator and task agent components within the AISFF framework, according to an embodiment.

FIG. 5 illustrates a user interface for event analysis and recommendation feedback within the AISFF framework, according to an embodiment.

FIG. 6 is a flow chart diagram illustrates a method of managing multimodal event data and anomalies using AI agents and a lifelong learning repository, according to an embodiment.

FIG. 7 illustrates an example of a specific format for sequence of agents and programs of the AISFF, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In the realm of modern technology, systems across various domains, such as autonomous vehicles, healthcare, and industrial equipment, are becoming increasingly complex. These systems generate vast amounts of data, including diagnostic, telemetry, and configuration data, which are important for monitoring and improving system performance. However, the sheer volume and complexity of this data pose significant challenges in identifying and understanding the root causes of unwanted or unanticipated behaviors. Traditional methods of system forensics, which involve manual analysis by experts, are often time-consuming and may not scale effectively with the growing complexity and data volume of these systems.

Existing solutions in the field of system forensics, such as AutoGen and AutoML, have attempted to address these challenges but have notable limitations. AutoGen, while facilitating the development of applications using multiple artificial intelligence (“AI”) agents, lacks a specific focus on orchestration for system forensics. The solution does not provide a comprehensive framework for managing and coordinating multiple AI agents to monitor and improve system performance. AutoGen does not include an explicit continuous and collective learning framework. AutoML, on the other hand, automates machine learning tasks but does not incorporate continuous learning or human-in-the-loop capabilities, which are crucial for adapting to new data and aligning with human preferences. These limitations hinder the ability of current solutions to effectively address the complexities of modern systems and their data.

The present disclosure introduces a novel AI system or framework for system forensics, designed to overcome the limitations of existing solutions. This framework, referred to as the AI for Systems Forensics Framework (AISFF), provides a comprehensive approach to monitoring and improving system performance across various domains. The AISFF leverages a central orchestrator to manage the operation of multiple AI agents, each tasked with specialized roles in analyzing multimodal data, detecting anomalies, and identifying root causes. By incorporating lifelong learning and expert-in-the-loop feedback, the framework ensures continuous adaptation to new data and scenarios, enhancing system robustness and performance. This disclosure offers a modular and adaptable solution, capable of addressing the diverse challenges posed by complex systems and their data.

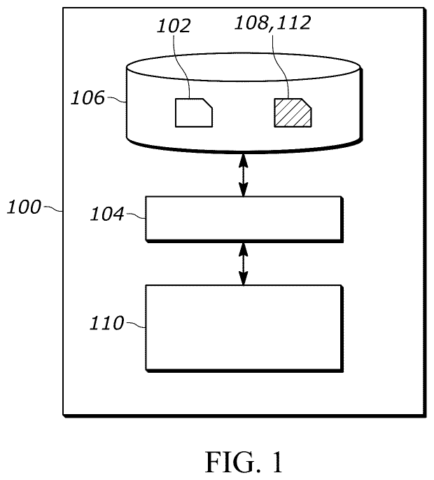

AI and machine learning (ML) models are an integral part of the inventions disclosed herein. FIG. 1 shows a system 100 for training a ML model, which can be or include a neural network for example. The system 100 can be used for the continuous learning methods disclosed herein, for example. The system 100 can also be used for training the individual AI agents and/or orchestrator as well. The system 100 can be used for any model in the AISFF.

The system 100 may comprise an input interface for accessing training data 102 for the ML model. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage. The data storage may also be cloud-based.

In some embodiments, the data storage 106 may further comprise a data representation 108 of an untrained version of the ML model which may be accessed by the system 100 from the data storage 106. It will be appreciated, however, that the training data 102 and the data representation 108 of the untrained ML model may also each be accessed from a different data storage, e.g., via a different subsystem of the data storage interface 104. Each subsystem may be of a type as is described above for the data storage interface 104. In other embodiments, the data representation 108 of the untrained ML model may be internally generated by the system 100 on the basis of design parameters for the ML model, and therefore may not explicitly be stored on the data storage 106.

The system 100 may further comprise a processor subsystem 110 which may be configured to, during operation of the system 100, provide an iterative function as a substitute for a stack of layers of the ML model (e.g., neural network) to be trained. Here, respective layers of the stack of layers being substituted may have mutually shared weights and may receive, as input, an output of a previous layer, or for a first layer of the stack of layers, an initial activation and a part of the input of the stack of layers. The processor subsystem 110 may be further configured to iteratively train the ML model using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the ML model. The system 100 may further comprise an output interface for outputting a data representation 112 of the trained ML model; this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ ML model may, during or after the training, be replaced at least in part by the data representation 112 of the trained ML model, in that the parameters of the ML model, such as weights, hyperparameters and other types of parameters of ML models, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ ML model. In some embodiments, the output interface may be separate from the data storage interface 104, but may in general be of a type as described above for the data storage interface 104.

The system 100 shown in FIG. 1 is one example of a system that may be utilized to train the machine learning models described herein.

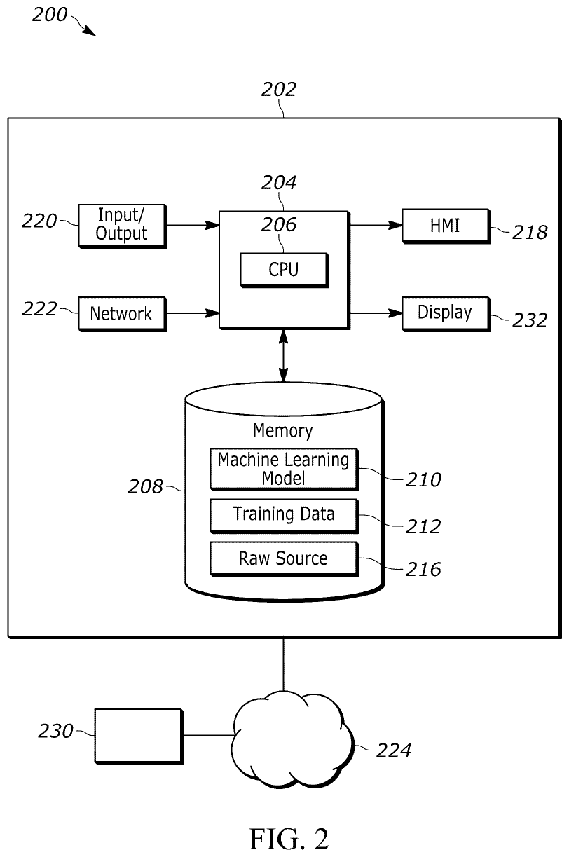

FIG. 2 depicts a system 200 to implement the ML models described herein, for example the agents and/or orchestrator in the AISFF. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the ×86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuity or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, sensors, touch screen, etc. Examples of output devices include monitors, touchscreens, speakers, head-up displays, vehicle control systems, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. The computing system 202 may include a display device 232. The computing system 202 may include hardware and software for outputting graphics and text information to the display device 232. The display device 232 may include an electronic display screen, projector, speaker or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate one or more of the machine learning models described herein, including the VLP Foundation model.

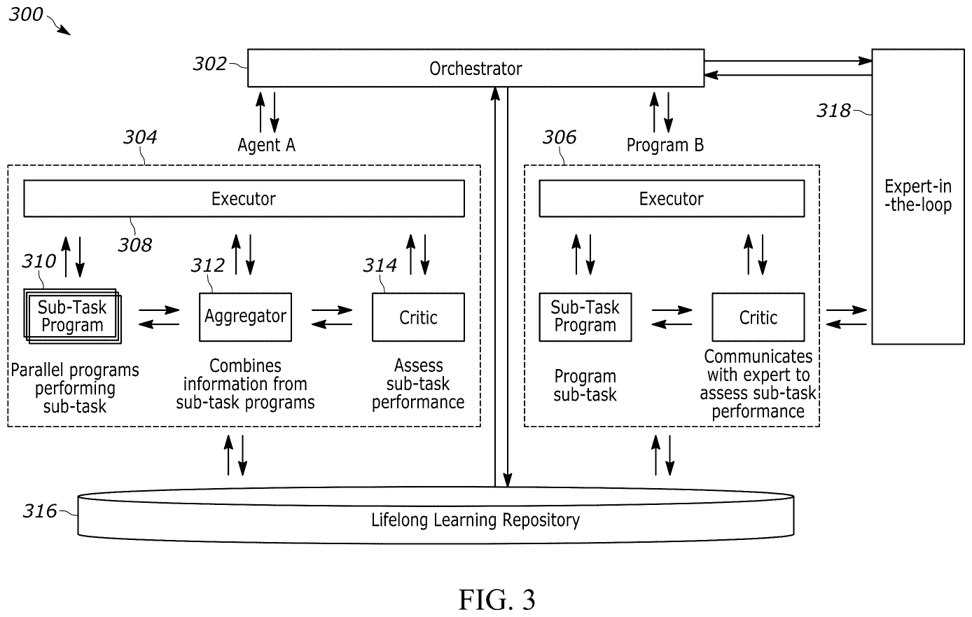

The computing system 202 may store a training dataset 212 for the machine-learning algorithm 210. The training dataset 212 may represent a set of previously constructed data for training the machine-learning algorithm 210. For example, the training dataset 212 can include data stored in the lifelong learning repository which is further described with reference to FIG. 3. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign). The input images may include various scenarios in which the objects are identified. The training dataset 212 may also include the text description of the scene (e.g., “the pedestrian is crossing the street”) that corresponds to the images detected by the vehicle sensors.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of other objects (e.g., other cars, pedestrians, etc.) in video images, annotate the occurrences, and/or command the vehicle to take a specific action (planning) based on the locational data of the detected object (perception) and the predicted future movement/location of the object (prediction). The machine-learning algorithm 210 may be programmed to process the raw source data 216 to identify the presence of the particular features. The machine-learning algorithm 210 may be configured to identify a feature in the raw source data 216 as a predetermined feature (e.g., road sign, pedestrian, etc.). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

The framework of FIG. 2 is merely exemplary. In the architecture depicted in FIG. 2, the orchestrator and AI agents are integral components of the system forensics framework. Each AI agent is equipped with a machine learning model 210, which is utilized to process and analyze data 212 stored in the lifelong learning repository. This repository serves as a comprehensive database, containing training data and raw source data 216 that the agents can access to perform their specialized tasks. The orchestrator, operating through the central processing unit (CPU) 206, coordinates the activities of the AI agents, ensuring that they work in concert to detect anomalies, identify root causes, and recommend solutions. The orchestrator leverages the network interface 222 to facilitate communication between agents and the lifelong learning repository, while the input/output interface 220 and human-machine interface (HMI) 218 enable interaction with human experts for expert-in-the-loop validation. The display 232 provides a visual representation of the system's operations, allowing for real-time monitoring and feedback. This integrated approach ensures that the system can adapt to new data and scenarios, enhancing its robustness and performance. Additional details regarding the Agents and Orchestrator will be described further below.

And, of course, the present disclosure is not limited to autonomous driving. The AISFF framework can be used in various environments, such as complex software systems, hardware testing applications, analysis of field data of operating hardware, recommending preferred configuration settings, monitoring biological systems, monitoring healthcare systems, and others.

FIG. 3 provides a high-level overview of the architecture and operation of the AISFF 300, according to an embodiment. The AISFF 300 can more generally be referred to as a system, more specifically a system troubleshooting and improving software programs or physical systems with continuous learning. FIG. 3 illustrates the interaction between an orchestrator, AI agents, and a lifelong learning repository. At the core of the system is the orchestrator 302, which coordinates the activities of multiple AI agents, such as Agent A 304 and Program B 306. Taking Agent A 304 as an example, each agent is equipped with an executor 308 that manages sub-task programs 310, also referred to as specialized tasks, which operate in parallel to perform specific functions. An aggregator 312 within each agent combines information from these sub-task programs, while a critic 314 assesses their performance. The orchestrator 302 facilitates communication between the agents 304 and the lifelong learning repository 316, ensuring that insights and knowledge are continuously updated. Additionally, the system incorporates an expert-in-the-loop 318, allowing human experts to provide feedback and validate the performance of the agents. This integrated approach enables the AISFF to adapt to new data and scenarios, enhancing its robustness and effectiveness in system forensics and performance optimization.

The system of FIG. 3 can be operated both online and offline. While many use cases can be for offline forensics, in principle, online forensics can be accomplished by the system as well. This is especially true for slower feedback system.

In FIG. 3, the distinction between an “agent” and a “program” is provided to distinguish between their roles and functionalities within the system. An “agent” refers to a more autonomous and intelligent entity within the system. Agents are designed to perform specific tasks or sets of tasks independently, often using machine learning models to make decisions and adapt to new data. In the AISFF, agents like Agent A are responsible for executing complex operations, such as analyzing data, detecting anomalies, and identifying root causes. They are equipped with capabilities to interact with other components, such as the orchestrator and the lifelong learning repository, to ensure that their tasks are aligned with the overall system objectives. A “program,” on the other hand, is generally a more narrowly focused component that performs specific sub-tasks within the broader framework. Programs may not have the same level of autonomy or decision-making capabilities as agents. In the AISFF 300, programs like Program B can be responsible for executing predefined sub-tasks, often under the guidance of an agent or the orchestrator. They may include sub-task programs that operate in parallel to achieve specific goals, such as data processing or aggregation. While these components can have distinctions, it should be understood that hereinafter, any reference to the functions of an “agent” can apply equally to a “program” unless the context dictates otherwise.

Each agent can incorporate various AI or machine learning (ML) models, such as any model for classification, regression, clustering, and/or dimensional reduction, such as neural networks, including pretrained foundation models like CLIP and GPT, convolutional neural networks, linear regression, logistic regression, support vector machines, random forest, xgboost, Kmeans, K nearest neighbors, etc, and dimensional reduction techniques like PCA or umap, etc.

The AISFF is adept at handling a wide variety of data types, making it suitable for complex and diverse data environments. One of the key strengths of AISFF is its ability to process multimodal data, which includes different types of data such as diagnostic, telemetry, and configuration data. This data can be heterogeneous, meaning that even within the same basic modality, the data can vary significantly. For example, different objects might be represented by varying numbers of time series, or images might have different numbers of channels, such as satellite images with or without infrared and water vapor concentration. The AISFF can leverage lifelong learning and multimodal large language model (MLLM) to orchestrate the processing of such diverse data, ensuring that each type of data is ingested and analyzed through appropriate pipelines.

Moreover, AISFF is designed to handle very complicated data, which often includes a large number of features, many missing entries, and asynchronous data channels or features. The data can be structured, semi-structured, or unstructured, and is inherently mutable, meaning that features may be renamed, removed, added, or altered at any point in time. Additionally, the data may be in sub-optimal formats that require additional preprocessing, such as asynchronous time series. The framework's architecture, which includes components like the orchestrator, executor, and sub-task programs, is specifically designed to manage these complexities. By utilizing the lifelong learning repository, AISFF can continuously update its models and strategies to adapt to new data formats and structures, ensuring robust and effective system forensics and performance optimization.

Within each AI agent, the executor is responsible for managing and executing specific sub-task programs. The Executor operates under the guidance of the orchestrator, ensuring that the sub-tasks are performed efficiently and effectively. The Executor acts as a sub-orchestrator, coordinating the execution of various sub-programs that are designed to address particular aspects of the overall task assigned to the agent. The Executor communicates the outcomes of these sub-tasks back to the orchestrator, providing a comprehensive analysis of the findings. This communication allows the orchestrator to synthesize the results from multiple agents and to update the lifelong learning repository with new insights. By managing the execution of sub-tasks, the Executor plays an important role in enabling the AISFF to adapt to new data and scenarios, thereby enhancing the system's robustness and performance in system forensics and performance optimization.

To perform the management and control tasks disclosed herein, the orchestrator can execute or be governed by a large language model (LLM), such as LLaMa or ChatGPT, for example.

Sub-task programs 310 are specialized components within the AISFF 300 that perform specific, narrowly defined tasks as part of the broader system analysis and optimization process. These programs operate under the guidance of the executor 308, which coordinates their activities to ensure that each sub-task is executed efficiently and effectively. Sub-task programs can run in parallel, allowing the system to handle multiple operations simultaneously, thereby enhancing overall performance and responsiveness. They are designed to address particular aspects of the system's operation, such as data processing, anomaly detection, or feature extraction, and they contribute to the system's ability to adapt to new data and scenarios by providing detailed insights and analyses.

In real-world applications, sub-task programs 310 can be employed in various domains to improve system performance and reliability. For instance, in an autonomous vehicle system, sub-task programs might analyze telemetry data to detect unusual driving patterns or potential hardware malfunctions. In a healthcare monitoring system, they could process patient telemetry and diagnostic data to identify early warning signs of health issues, enabling timely interventions. In industrial equipment maintenance, sub-task programs might evaluate sensor data to predict equipment failures and schedule preventive maintenance, reducing downtime and operational costs.

Taking an autonomous vehicle system as an example, sub-task programs may operate by continuously monitoring data streams generated from various sensors and components within the vehicle, such as speed, acceleration, braking patterns, engine performance, and environmental conditions. These data streams may have already been saved in the lifelong learning repository 316 that was generated from prior executions of a target autonomous driving system. By applying machine learning algorithms, the sub-task programs can identify deviations from normal operating conditions, such as erratic steering, sudden braking, or unexpected engine behavior, which may indicate a potential issue. The programs can also correlate these anomalies with historical data stored in the lifelong learning repository to determine if similar patterns have been observed in the past, thereby enhancing the accuracy of anomaly detection and root-cause analysis.

For example, if a sub-task program detects a pattern of harsh braking events, it can analyze the preceding telemetry data to identify contributing factors, such as road conditions, driver inputs, or sensor malfunctions. This analysis can help determine whether the issue is due to external factors, such as slippery roads, or internal factors, such as a failing brake system. Similarly, if the program identifies unusual engine vibrations, it can cross-reference this data with historical maintenance records and sensor readings to pinpoint potential mechanical failures.

Taking healthcare monitoring as another example, sub-task programs may be designed to process and analyze patient telemetry and diagnostic data to identify early warning signs of health issues. These programs can monitor data that was previously generated from various medical devices and sensors, such as heart rate monitors, blood pressure cuffs, and glucose meters. By applying advanced machine learning algorithms, the sub-task programs can detect deviations from normal health parameters, such as irregular heartbeats, sudden spikes in blood pressure, or abnormal glucose levels. These deviations may indicate potential health concerns that require further investigation or immediate intervention. The programs can also correlate these anomalies with historical patient data stored in the lifelong learning repository to determine if similar patterns have been observed previously, thereby enhancing the accuracy of diagnosis and treatment recommendations.

For example, if a sub-task program detects a pattern of irregular heartbeats, it can analyze the preceding telemetry data to identify contributing factors, such as recent physical activity, medication changes, or stress levels. This analysis can help determine whether the issue is due to external factors or an underlying medical condition. Similarly, if the program identifies abnormal glucose levels, it can cross-reference this data with historical dietary records and insulin usage to pinpoint potential causes. By providing real-time insights and recommendations, these sub-task programs enable healthcare providers to make informed decisions, facilitate timely interventions, and ultimately improve patient outcomes. This proactive approach to healthcare monitoring enhances the safety and reliability of patient care systems.

The sub-task programs may perform detailed log analysis to identify patterns or anomalies in the data, leveraging historical data and insights stored in the lifelong learning repository 316 to enhance the accuracy and relevance of their findings. Additionally, the sub-task programs can be tasked with identifying and processing event data that precedes anomalies, enabling the system to pinpoint potential root causes and provide actionable insights for resolving issues.

The aggregator 312 can be relied upon for synthesizing the outputs from various sub-task programs 310. As these sub-task programs operate in parallel, they generate a multitude of insights and data points that need to be consolidated to form a coherent understanding of the system's status. In embodiments, the aggregator 312 collects and combines the information produced by these sub-task programs, ensuring that the diverse outputs are integrated into a unified dataset. This integration aids in providing a comprehensive view of the system's performance and identifying any anomalies or patterns that may require further investigation. By consolidating the data, the aggregator enables the system to leverage the full spectrum of insights generated by the sub-task programs, facilitating more accurate anomaly detection, root-cause analysis, and decision-making processes.

The aggregated information is then passed on to the critic 314, which assesses the performance of the sub-task programs and provides feedback to the orchestrator and other components of the AISFF, ensuring continuous improvement and adaptation to new data and scenarios. In embodiments, after the aggregator 312 consolidates the outputs from various sub-task programs 310, the critic 314 steps in to assess the performance of these sub-tasks. It evaluates the aggregated data to determine the quality and reliability of the insights generated by the sub-task programs. This assessment involves checking for consistency, accuracy, and relevance of the findings in relation to the system's objectives. The critic 314 communicates its evaluations back to the executor 308, providing feedback on the performance of the sub-task programs. This feedback loop is crucial for continuous improvement, as it allows the executor to make informed decisions about adjusting or refining the sub-task programs to enhance their effectiveness.

As an example, the critic can operate to demand model performance to exceed some threshold. For example, if the agents subprogram's achieve 70% confidence on the initial pass, but the performance demands >75%, the critic will insist the agent tries to refine hyperparameters, engage is some additional feature engineering, and/or use a more powerful model until the required performance is achieved, which may involve requesting the orchestrator to contact previous agents in the workflow.

From a structural standpoint, the agent 304 utilizes a combination of processor and memory resources to perform its functions effectively. The processor within agent 304 is responsible for executing the computational tasks required by the sub-task programs, the aggregator, and the critic. It processes the data inputs, runs machine learning algorithms, and performs the necessary calculations to analyze and interpret the data. The memory, on the other hand, is used to store the data being processed, the intermediate results, and the models used by the agent. It also holds the configuration settings and historical data accessed from the lifelong learning repository. The executor 308 within agent 304 coordinates the activities of the sub-task programs 310, ensuring that they operate in parallel and efficiently utilize the processor's capabilities. The aggregator 312 collects and combines the outputs from these sub-task programs, while the critic 314 evaluates their performance, all of which rely on the seamless interaction between the processor and memory to maintain high-speed data processing and real-time analysis.

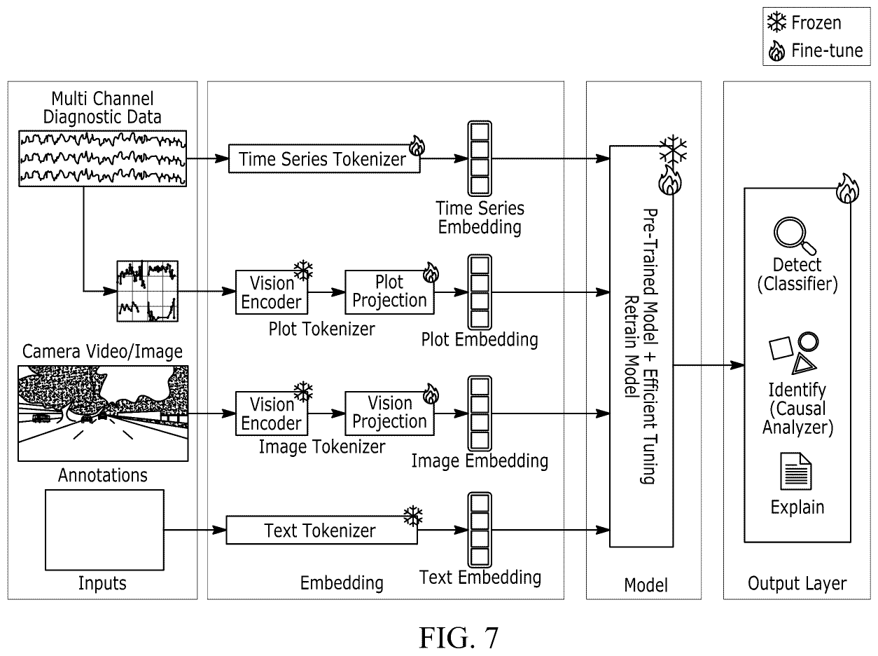

FIG. 7 illustrates an example of a specific format for sequence of agents and programs of the AISFF, according to an embodiment. The orchestrator first requests a data agent to have the input data preprocessed and formatted into acceptable format. The input data can be of different modality including tabular time series (e.g. multi-channel diagnostic data), camera video or image data, text annotations, and the like. The orchestrator then assigns an encoding agent to embed the data and run it through the model into encodings. Here, a different encoder is used for each type of modality with regard to input, transferring the original input data to some latent space representation. The illustrated “model” here is where these latent space representations are combined and jointly processed. The model includes but is not limited to, pretrained LLM family models (namely GPT, LLAMA, RoBERTa, Albert etc.), retrained model based on transformer architecture or other model architectures. The orchestrator then assigns another agent to handle the specific downstream task. In the event that the downstream task requested precision cannot be met, additional feature engineering from the preceding step may be requested. Depending on the function the model is to achieve, different task heads can be connected to the model for generating different types of outputs.

Returning to FIG. 3, the Lifelong Learning Repository 316 serves as a comprehensive database that stores and manages the knowledge accumulated over time. This repository is designed to facilitate continuous learning and adaptation by retaining previously-stored multimodal data, detected anomalies, and refined solutions from past analyses. It acts as a dynamic knowledge base that the orchestrator and AI agents can access to enhance their decision-making processes. By maintaining a historical record of system behaviors, anomalies, and expert feedback, the Lifelong Learning Repository enables the framework to improve its performance and accuracy in identifying and addressing system issues. This repository can prevent catastrophic forgetting, allowing the system to incorporate new information while retaining valuable insights from past experiences.

In practical terms, the Lifelong Learning Repository 316 supports various functions within the AISFF. For instance, in an autonomous vehicle system, it stores telemetry data and patterns of driving behavior that have been analyzed by sub-task programs. This allows the system to recognize and respond to similar patterns in the future more effectively. For example, in a healthcare monitoring system, the repository retains patient telemetry and diagnostic data, enabling the system to identify early warning signs of health issues based on historical trends. By providing a rich source of contextual information, the Lifelong Learning Repository empowers the AISFF to deliver more accurate and timely recommendations, ultimately enhancing the robustness and reliability of the systems it monitors.

The AISFF can include one or more of the following functions. First, the AISFF can clean and learn from multimodal data. In embodiments, the orchestrator 302 initiates the process by delegating the task of cleaning and learning from multimodal data to the appropriate AI agents. The executor 308 within each agent coordinates the sub-task programs 310, which are responsible for processing the raw data, removing noise, and extracting relevant features. These sub-task programs utilize machine learning models to identify patterns and insights from the data. The cleaned and processed data is then stored in the lifelong learning repository 316, where it can be accessed for future analyses and learning tasks.

Second, the AISFF can adapt to additional data without catastrophic forgetting. In embodiments, the orchestrator 302 ensures that the system can adapt to new data inputs by leveraging the lifelong learning repository 316. The executor 308 manages the sub-task programs 310, which are designed to incorporate new information while retaining previously learned knowledge. This is achieved through continuous learning algorithms that prevent catastrophic forgetting. The lifelong learning repository serves as a dynamic knowledge base, allowing the system to update its models and strategies based on the latest data and insights.

Third, the AISFF can automate machine learning tasks to reduce developer effort. In embodiments, the orchestrator 302 automates the execution of machine learning tasks by assigning them to the appropriate AI agents. The executor 308 oversees the sub-task programs 310, which handle tasks such as data preprocessing, model training, and validation. By automating these processes, the system reduces the need for manual intervention by developers, streamlining the workflow and improving efficiency. The lifelong learning repository 316 stores the results and models generated by these automated tasks, enabling continuous improvement and optimization.

Fourth, the AISFF can produce quality class labels for detected patterns. In embodiments, the orchestrator 302 directs the AI agents to generate quality class labels for patterns detected in the data. The executor 308 coordinates the sub-task programs 310, which apply classification algorithms to label the data accurately. These labels are then validated and refined using historical data and insights stored in the lifelong learning repository 316. This process ensures that the system produces reliable and meaningful labels that can be used for further analysis and decision-making.

Fifth, the AISFF can identify candidate root causes. In embodiments, the orchestrator 302 assigns the task of identifying candidate root causes of anomalies to the AI agents. The executor 308 manages the sub-task programs 310, which analyze the data to pinpoint potential causes of detected issues. These programs utilize advanced analytics and machine learning techniques to correlate anomalies with historical data stored in the lifelong learning repository 316. By identifying root causes, the system can provide actionable insights for addressing and resolving issues.

Sixth, the AISFF can recommend solutions. In embodiments, the orchestrator 302 facilitates the recommendation of solutions by coordinating the efforts of the AI agents. The executor 308 oversees the sub-task programs 310, which generate potential solutions based on the identified root causes and historical data in the lifelong learning repository 316. These recommendations are then evaluated and refined to ensure their effectiveness and applicability to the current context.

Seventh, the AISFF can explain findings and reasoning accurately and coherently. In embodiments, the orchestrator 302 ensures that the system can explain its findings and reasoning in a clear and coherent manner. The executor 308 manages the sub-task programs 310, which generate explanations and justifications for the detected patterns, root causes, and recommended solutions. These explanations are informed by the data and insights stored in the lifelong learning repository 316, providing a comprehensive understanding of the system's operations and decisions.

Eighth, the AISFF can adapt to and evolve with expert feedback. The orchestrator 302 incorporates expert feedback into the system's operations by interacting with the expert-in-the-loop 318. The executor 308 coordinates the sub-task programs 310, which adjust their processes and models based on the feedback received. The lifelong learning repository 316 is updated with the refined models and strategies, ensuring that the system evolves and improves over time.

Ninth, the AISFF can orchestrate the operations of the above tasks. The orchestrator manages the operation of all the tasks within the AISFF. It ensures that the AI agents, executors, and sub-task programs work in harmony to achieve the system's objectives. By managing the flow of information and tasks, the orchestrator enables the system to operate efficiently and effectively, leveraging the lifelong learning repository to support continuous learning and adaptation.

For a given use case, only a subset of the above tasks may be warranted. Specific use cases include, but are not limited to, the following: detecting and identifying issues with autonomous vehicle software and/or hardware, e.g., by classifying unwanted vehicle behavior, identifying their underlying causes, and homing in on the specific hardware and/or software subsystems that in need of remedy to resolve the problem; analyzing test data for various mechanical systems, such as appliances or industrial equipment, to determine the type and health of the test, and to understand causes of performance deficiencies and possible solutions; Identify coverage gaps in the testing and validation of autonomous vehicle software and/or hardware, e.g. by identifying driving scenarios that are under-represented in the recorded data and recommend remediation action to fulfill desired coverage; analyzing field operation data for various mechanical systems, such as appliances or industrial equipment, to identify patterns that warn of imminent failures or required maintenance, and or propose modifications to configurations to improve performance; analyzing software design metadata and existing test data to recommend configuration settings to reduce required development and analysis effort for meeting test objectives, such as target following, corrective response, and environment detection; examining performance of complex software systems, such as power grid management or weather forecasting, to identify reduced performance scenarios and the underlying causes, and recommend internal modules to improve; using telemetry data to monitor biological systems, such as by monitoring hydroponic systems to recommend adjusted concentrations of nutrients to improve yield, or provide early alerts for suspected bacterial or fungal contaminations; using telemetry data to assist with personalized healthcare, e.g., by monitoring data from cardiac patients, alerting them when data indicates issues, and informing medical providers of the suspected issue and solutions for quicker intervention.

The AISFF is distinguished from AutoGen and AutoML through its comprehensive approach to system monitoring and forensics, leveraging a unique combination of continuous learning, expert feedback, and modular orchestration. Unlike AutoGen, which focuses on enabling customizable and conversable agents for diverse applications, AISFF is specifically designed for system forensics, incorporating a central orchestrator that manages the operation of multiple AI agents. This orchestrator is responsible for delegating tasks, managing data flows, and ensuring that the system adapts to new data and scenarios without forgetting previous information. In contrast, AutoGen does not emphasize the orchestration and coordination required for system forensics. Furthermore, AISFF integrates lifelong learning capabilities, allowing it to adapt to new data inputs without catastrophic forgetting, a feature not explicitly addressed by AutoGen.

AutoML, on the other hand, automates individual machine learning tasks such as data cleaning, feature engineering, and model selection, but lacks a design for continuous learning and human-in-the-loop capabilities. AISFF addresses these limitations by incorporating an expert-in-the-loop approach, where human experts provide feedback and guidance to refine system performance and align with human preferences. The framework's modular design, as illustrated in FIGS. 3-5, allows for flexibility and scalability, enabling it to handle the complexities of system monitoring and forensics across various domains, such as autonomous vehicles and healthcare systems.

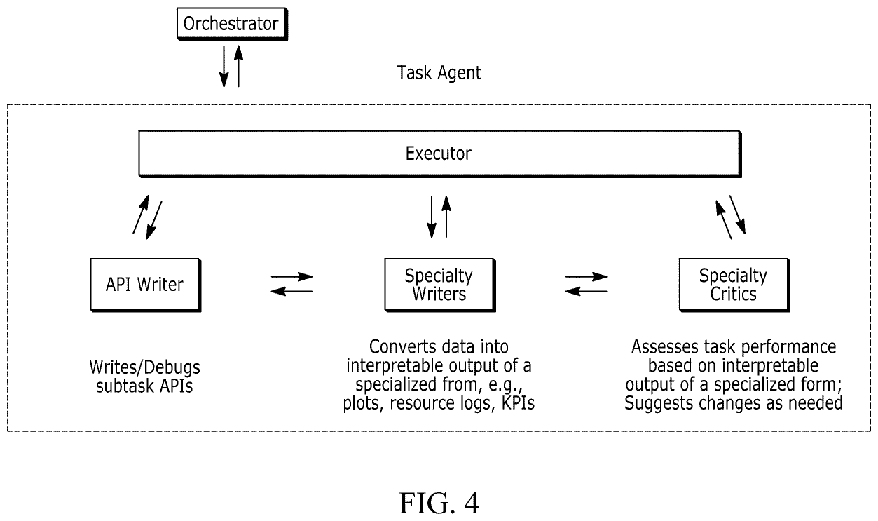

FIG. 4 illustrates an example of a multi-agent (multi-program) design for one task, which in turn includes child agents in a predefined conversation pattern. The central child agent is an executor with two primary roles: (1) assigning API calls to the designed subtask APIs, thereby saving effort required to troubleshoot live code and specifying the diagnostics available with each call (function version, arguments, date, etc.); and (2) assigning modalities of interest, thereby pooling a mixture of critics for improving subtasks as needed before the task is deemed complete.

The API writer in FIG. 4 is a component that facilitates the interaction between the orchestrator and the various sub-task programs by generating and managing the necessary API calls. The API writer ensures that the sub-task programs receive the correct inputs and configurations required to perform their designated functions. The API writer acts as an intermediary, translating the orchestrator's high-level directives into specific API calls that trigger the execution of sub-tasks. This component maintains the modularity and flexibility of the AISFF, allowing the system to adapt to different data types and operational requirements. By managing the API interactions, the API writer contributes to the system's ability to automate machine learning tasks and reduce developer effort.

The specialty writers in FIG. 4 are components designed to convert complex data outputs from the sub-task programs into formats that are easily interpretable by human experts. These writers are important in ensuring that the system's findings and recommendations are communicated effectively to the expert-in-the-loop. They transform raw data and analytical results into visualizations, reports, or other human-readable formats, facilitating expert validation and feedback. The specialty writers enhance the system's ability to explain the system's findings and reasoning accurately and coherently, which is important for aligning the system's operations with human preferences and domain-specific knowledge.

The specialty critics in FIG. 4 are components that evaluate the performance and reliability of the sub-task programs'outputs. They assess the quality and accuracy of the insights generated by the sub-task programs, providing feedback to the executor and orchestrator. The specialty critics aid in the continuous improvement of the AISFF by identifying areas where the sub-task programs can be refined or adjusted to enhance their effectiveness. By ensuring that the system's outputs meet the desired standards of accuracy and relevance, the specialty critics contribute to the overall robustness and reliability of the AISFF in various operational contexts.

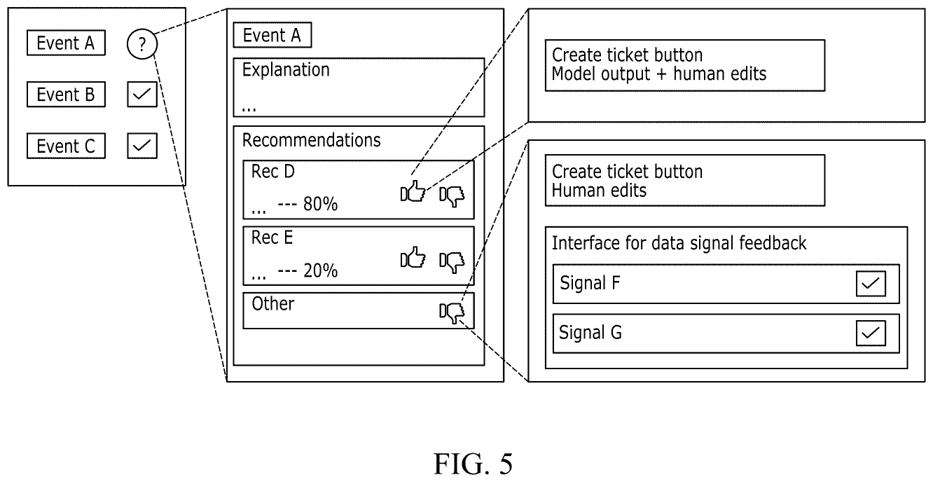

FIG. 5 is an example of a user interface for data signal feedback. This user interface can be displayed graphically on a display for an expert in the loop, for example. The expert would provide the system with input regarding a number of signals and data that they would point to in their analysis. This would include data that the expert would use in its troubleshooting exercise. By providing this to the system 300, the models are informed and improved. The expert can also give a binary feedback (e.g., yes or no, thumbs-up or thumbs-down) as to the recommended resolutions, thus improving the system 300.

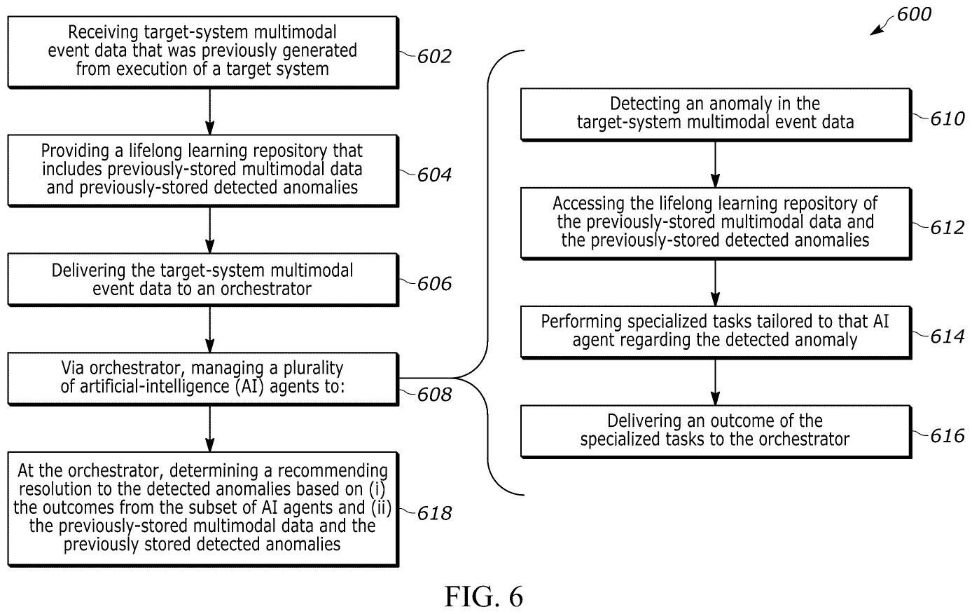

FIG. 6 illustrates a method 600 that can be performed by the systems disclosed herein. For example, the method may be carried out by one or more of the processors disclosed herein, executing instructions stored in memory.

The method 600 involves receiving and processing data, detecting anomalies, and managing AI agents to provide resolutions. This method can be implemented by a system that includes an orchestrator and a lifelong learning repository.

At step 602, the method 600 involves receiving target-system multimodal event data that was previously generated from the execution of a target system. This data serves as the foundational input for subsequent analysis and processing. In embodiments, the data can be retrieved from some database other than the lifelong learning repository because it has not yet been processed by the AISFF system. The target-system multimodal event data can include diagnostic data, telemetry, and configuration data.

At step 604, the method 600 includes providing a lifelong learning repository that includes previously-stored multimodal data and previously-stored detected anomalies from prior executions of the target system or other target systems. This repository acts as a knowledge base, enabling the system to leverage historical data and insights for improved anomaly detection and resolution.

At step 606, the method 600 includes delivering the target-system multimodal event data to an orchestrator. The orchestrator is responsible for coordinating the analysis and management of the data, facilitating the interaction between various components of the system.

At step 608, the method 600 includes managing a plurality of artificial-intelligence (AI) agents via the orchestrator. These AI agents are tasked with analyzing the data and detecting anomalies, utilizing the orchestrator's capabilities to optimize their performance. Step 608 can include sub-steps 610 through 616.

At step 610, the method 600 includes detecting an anomaly in the target-system multimodal event data. This step plays an important role in identifying deviations from expected behavior, which may indicate potential issues or areas for improvement.

At step 612, the method 600 includes accessing the lifelong learning repository of the previously-stored multimodal data and the previously-stored detected anomalies. This access allows the system to compare current anomalies with historical data, enhancing the accuracy and relevance of the analysis.

At step 614, the method 600 includes performing specialized tasks tailored to the AI agent regarding the detected anomaly. These tasks are designed to address the specific characteristics of the anomaly, leveraging the expertise and capabilities of the AI agents.

At step 616, the method 600 includes delivering an outcome of the specialized tasks to the orchestrator. This outcome provides insights and recommendations for resolving the detected anomaly, contributing to the overall effectiveness of the system.

At step 618, the method 600 includes determining, at the orchestrator, a recommending resolution to the detected anomalies. This resolution is based on (i) the outcomes from the subset of AI agents and (ii) the previously-stored multimodal data and the previously stored detected anomalies in the lifelong learning repository, ensuring a comprehensive and informed approach to anomaly management.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for troubleshooting and improving software programs or physical systems with continuous learning, the method comprising:
receiving target-system multimodal event data that was previously generated from execution of a target system, wherein the target-system multimodal event data includes at least one of sensor data, diagnostic data, configuration data, and source code;
providing a lifelong learning repository that includes previously-stored multimodal data and previously-stored detected anomalies from prior executions of the target system or other target systems;
delivering the target-system multimodal event data to an orchestrator;
utilizing the orchestrator to manage a plurality of artificial-intelligence (AI) agents, wherein the orchestrator selects, based on the target-system multimodal event data, a subset of the AI agents to perform operations including:
detecting an anomaly in the target-system multimodal event data,
accessing the lifelong learning repository of the previously-stored multimodal data and the previously-stored detected anomalies,
performing specialized tasks tailored to that AI agent regarding the detected anomaly based on the previously-stored multimodal data and the previously-stored detected anomalies in the lifelong learning repository to identify candidate root-causes of the detected anomalies, and
delivering an outcome of the specialized tasks to the orchestrator; and
at the orchestrator, determining a recommending resolution to the detected anomalies based on (i) the outcomes from the subset of AI agents and (ii) the previously-stored multimodal data, the previously stored detected anomalies, and previously-computed model weights in the lifelong learning repository.

2. The method of claim 1, further comprising:
utilizing the orchestrator to deliver the recommended resolution to a human expert for expert-in-loop validation;
refining the recommended resolution based on the expert-in-loop validation; and
storing the refined recommended resolution in the lifelong learning repository for future root-cause analyses via continuous learning.

3. The method of claim 1, further comprising:
at the orchestrator, comparing the recommended resolution to a confidence threshold, and
in response to the recommended resolution being below the confidence threshold, utilizing the orchestrator to deliver the recommended resolution to a human expert for expert-in-loop validation.

4. The method of claim 3, further comprising:
in response to the recommended resolution exceeding the confidence threshold, utilizing the orchestrator to direct the agents to perform sub-actions pursuant to the recommended resolutions.

5. The method of claim 1, wherein the specialized tasks include at least one of (i) performing log analysis on the target-system multimodal data, and (ii) identifying and processing the target-system multimodal event data that immediately precedes the detected anomaly.

6. The method of claim 1, wherein the target-system multimodal event data includes image data, video data, or audio data.

7. The method of claim 1, wherein each AI agent includes an aggregator configured to aggregate outcomes of the specialized tasks and provide a consolidated view of potential root causes and recommended resolutions.

8. A computer system for troubleshooting and improving software programs or physical systems with continuous learning, the computer system comprising:
a plurality of processors that, when executed, are programmed to perform:
receiving target-system multimodal event data that was previously generated from execution of a target system, wherein the target-system multimodal event data includes diagnostic data, telemetry, and configuration data;
providing a lifelong learning repository that includes previously-stored multimodal data and previously-stored detected anomalies from prior executions of the target system or other target systems;
delivering the target-system multimodal event data to an orchestrator;
utilizing the orchestrator to manage a plurality of artificial-intelligence (AI) agents, wherein the orchestrator selects, based on the target-system multimodal event data, a subset of the AI agents to perform operations including:
detecting an anomaly in the target-system multimodal event data,
accessing the lifelong learning repository of the previously-stored multimodal data and the previously-stored detected anomalies,
performing specialized tasks tailored to that AI agent regarding the detected anomaly based on the previously-stored multimodal data and the previously-stored detected anomalies in the lifelong learning repository to identify candidate root-causes of the detected anomalies, and
delivering an outcome of the specialized tasks to the orchestrator; and
at the orchestrator, determining a recommending resolution to the detected anomalies based on (i) the outcomes from the subset of AI agents and (ii) the previously-stored multimodal data, the previously stored detected anomalies, and previously-computed model weights in the lifelong learning repository.

9. The system of claim 8, wherein the processors, when executed, are further programmed to perform:
utilizing the orchestrator to deliver the recommended resolution to a human expert for expert-in-loop validation;
refining the recommended resolution based on the expert-in-loop validation; and
storing the refined recommended resolution in the lifelong learning repository for future root-cause analyses via continuous learning.

10. The system of claim 8, wherein the processors, when executed, are further programmed to perform:
at the orchestrator, comparing the recommended resolution to a confidence threshold, and
in response to the recommended resolution being below the confidence threshold,
utilizing the orchestrator to deliver the recommended resolution to a human expert for expert-in-loop validation.

11. The system of claim 10, wherein the processors, when executed, are further programmed to perform:
in response to the recommended resolution exceeding the confidence threshold, utilizing the orchestrator to direct the agents to perform sub-actions pursuant to the recommended resolutions.

12. The system of claim 8, wherein the specialized tasks include at least one of (i) performing log analysis on the target-system multimodal data, and (ii) identifying and processing the target-system multimodal event data that immediately precedes the detected anomaly.

13. The system of claim 8, wherein the target-system multimodal event data includes image data, video data, or audio data.

14. The system of claim 8, wherein each AI agent includes an aggregator configured to aggregate outcomes of the specialized tasks and provide a consolidated view of potential root causes and recommended resolutions.

15. The system of claim 8, wherein the orchestrator is governed by or executes a large language model (LLM).

16. A non-transitory computer-readable storing medium storing instructions that, when executed by a processor, cause the processor to perform steps comprising:
receiving target-system multimodal event data that was previously generated from execution of a target system, wherein the target-system multimodal event data includes diagnostic data, telemetry, and configuration data;
providing a lifelong learning repository that includes previously-stored multimodal data and previously-stored detected anomalies from prior executions of the target system or other target systems;
delivering the target-system multimodal event data to an orchestrator;
utilizing the orchestrator to manage a plurality of artificial-intelligence (AI) agents, wherein the orchestrator selects, based on the target-system multimodal event data, a subset of the AI agents to perform operations including:
detecting an anomaly in the target-system multimodal event data,
accessing the lifelong learning repository of the previously-stored multimodal data and the previously-stored detected anomalies,
performing specialized tasks tailored to that AI agent regarding the detected anomaly based on the previously-stored multimodal data and the previously-stored detected anomalies in the lifelong learning repository to identify candidate root-causes of the detected anomalies, and
delivering an outcome of the specialized tasks to the orchestrator; and
at the orchestrator, determining a recommending resolution to the detected anomalies based on (i) the outcomes from the subset of AI agents and (ii) the previously-stored multimodal data, the previously stored detected anomalies, and previously-computed model weights in the lifelong learning repository.

17. The non-transitory computer-readable storing medium of claim 16, wherein the instructions, when executed by the processor, cause the processor to perform further steps comprising:
utilizing the orchestrator to deliver the recommended resolution to a human expert for expert-in-loop validation;
refining the recommended resolution based on the expert-in-loop validation; and
storing the refined recommended resolution in the lifelong learning repository for future root-cause analyses via continuous learning.

18. The non-transitory computer-readable storing medium of claim 16, wherein the instructions, when executed by the processor, cause the processor to perform further steps comprising:
at the orchestrator, comparing the recommended resolution to a confidence threshold, and
in response to the recommended resolution being below the confidence threshold, utilizing the orchestrator to deliver the recommended resolution to a human expert for expert-in-loop validation.

19. The non-transitory computer-readable storing medium of claim 18, wherein the instructions, when executed by the processor, cause the processor to perform further steps comprising:
in response to the recommended resolution exceeding the confidence threshold, utilizing the orchestrator to direct the agents to perform sub-actions pursuant to the recommended resolutions.

20. The non-transitory computer-readable storing medium of claim 18, wherein the specialized tasks include at least one of (i) performing log analysis on the target-system multimodal data, and (ii) identifying and processing the target-system multimodal event data that immediately precedes the detected anomaly.
